(19) United States
(12) Patent Application Publication
(10) Pub. No.: US 2026/0276141 A1
(43) Pub. Date: Sep. 17, 2026

(54) UNIVERSAL HOLDER

(71) Applicant: Randy T. Nagata, Bailey, CO (US)

(72) Inventor: Randy T. Nagata, Bailey, CO (US)

(21) Appl. No.: 19/672,192

(22) Filed: May 8, 2026

Related U.S. Application Data
(63) Continuation-in-part of application No. 18/759,578, filed on Jun. 28, 2024, now Pat. No. 12,644,561.
(60) Provisional application No. 63/510,798, filed on Jun. 28, 2023.

(51) Int. Cl. F16M 13/02; A01K 97/10; F16M 11/20

(52) U.S. Cl. CPC F16M 13/022; F16M 11/2078; A01K 97/10; F16M 2200/022; F16M 2200/068

(57) ABSTRACT

An apparatus for holding an object is provided. The apparatus includes a tightening mechanism, a fastening rod operatively connected to the tightening mechanism, and first and second articulating rods. The first articulating rod comprises a first engagement mechanism operatively connected to the fastening rod and a first engagement rod having a proximate end operatively connected to the first engagement mechanism and a distal end configured to engage with a first ball and socket comprising a protruded portion configured to engage with an attachment. The second articulating rod comprises a second engagement mechanism operatively connected to the fastening rod and a second engagement rod having a proximate end operatively connected to the second engagement mechanism and a distal end configured to engage with a second ball and socket comprising a second protruded portion configured to engage with a clamp.

### CROSS-REFERENCE TO RELATED APPLICATION(S)

This application is a continuation-in-part of U.S. patent application Ser. No. 18/759,578, filed on Jun. 28, 2024, which claims priority to U.S. Provisional Application No. 63/510,798, filed Jun. 28, 2023, the contents of both of which are herein incorporated in their entireties.

### TECHNICAL FIELD

The present application is directed to the fields of holding apparatuses, including a cylindrical receptacle to receive a distal end of an object, such as a fishing rod or an umbrella.

### BACKGROUND

A wide variety of holding apparatuses exist today, but each of these holding apparatuses are inflexible and cumbersome. For example, many fishermen use a rod holder that is comprised of a receptacle with a spike on one end of the receptacle, and the spike is used to dig into the ground, so the fishing rod can be help in the receptacle, while the receptacle is mounted to the ground. This type of holder does not pivot and cannot be attached to other support structures.

In other examples, holding apparatuses may be permanently attached to other objects, such as chairs, tables, and tent frames. These holding apparatuses are inflexible because they cannot be removed from these structures, but instead must remain affixed to a larger object. If a user desired to remove this holder from the structure, the user would risk damaging the structure to which the holder is permanently affixed.

Another drawback of current holding apparatuses is that they fail to position the receptacle at a desired angle. For instance, many holders have a fixed position, so they cannot rotate or be turned to a certain angle relative to, for example, a body of water where a fishing line will be cast out of a fishing rod or relative to the wind or rain where an umbrella will be placed to protect a user from the elements.

As such, a current need exists for a more flexible and versatile holding apparatus that can receive various items in a receptacle. A need exists to be able to rotate the receptacle in certain positions but also maintain sturdiness or rigidness of the apparatus.

It is with respect to these and other general considerations that the aspects disclosed herein have been made. Also, although relatively specific problems may be discussed, it should be understood that the examples should not be limited to solving the specific problems identified in the background or elsewhere in the disclosure.

### BRIEF DESCRIPTION OF THE DRAWINGS

Non-limiting and non-exhaustive examples are described with reference to the following figures.

FIG. 1 is a side perspective view which illustrates a particular embodiment of the universal holder.

FIG. 2 is a zoomed-in perspective view which illustrates the connection point between one of the articulating rods and the clamp.

FIG. 3 is a side perspective view which illustrates a clamp connected to the universal holder.

FIG. 4 is a zoomed-in perspective view which illustrates the connection point between one of the articulating rods and the holder.

FIG. 5 is a perspective view of a holder system with an internal engagement system, in accordance with one or more embodiments.

FIG. 6A is a perspective view of an engagement mechanism with an aperture, in accordance with one or more embodiments.

FIG. 6B is a perspective view of an engagement mechanism with an aperture, in accordance with one or more embodiments.

FIG. 6C is a perspective view of an engagement mechanism with an aperture, in accordance with one or more embodiments.

FIG. 7A is a perspective view of ball joint engagement system with a tapered engagement rod, in accordance with one or more embodiments.

FIG. 7B is a perspective view of ball joint engagement system with a tapered engagement rod, in accordance with one or more embodiments.

FIG. 8 is an exploded view of internal mechanisms for a holder system, in accordance with one or more embodiments.

FIG. 9A is a perspective view of a holder system with a magnetic attachment, in accordance with one or more embodiments.

FIG. 9B is a perspective view of a holder system with a phone holding attachment, in accordance with one or more embodiments.

FIG. 9C is a perspective view of a holder system with a clamp attachment, in accordance with one or more embodiments.

FIG. 10 is a perspective view of a holder system with multiple attachments, in accordance with one or more embodiments.

FIG. 11 is a perspective view of a holder system with a single articulating rod, in accordance with one or more embodiments.

FIG. 12 is a perspective view of a holder system with a plurality of articulating rods, in accordance with one or more embodiments.

FIG. 13 is a flow diagram illustrating an exemplary method for engaging a holder in place, in accordance with one or more embodiments.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems, or devices. The following detailed description is, therefore, not to be taken in a limiting sense.

Embodiments of the present application are directed to a universal holder, specifically to a holding apparatus that comprises a cylindrical receptacle attached to at least one articulating rod (or arm) via a rotating join, such as a ball and socket joint and a threaded screw (or connector). The articulating rod may be connected to a clamp that may be secured to a structure to hold the holder apparatus in place.

The clamp may be connected to the articulating rod with a ball and socket joint and be able to rotate around the axis of the ball and socket joint. The clamp may also comprise at least two notched padded jaws that may be actuated by at least one threaded rod with a handle. The handle may be turned to tighten the clamp jaws together. The jaw components of the clamp may be comprised of a molded synthetic rubber material or a steel material, in some examples. The clamp jaws may comprise receiving points (holes) that provide for a replaceable, non-slip, non-marring surface.

The threaded rod that is affixed to the clamp may be attached to at least one barrel nut that is positioned through receiving points on each padded jaw. The clamp may be configured to attach to certain structures, such as a folding chair frame, a table side, a tent frame, a bucket, a tree branch, a wheelchair, or a tent spike, among other structures.

The clamp may be affixed to at least one articulating rod. In some example aspects, the universal holder may comprise at least two articulating rods, with one rod attached to the clamp portion and the other articulating rod attached to a receptacle. Both rods may be attached a shared joint that is held together via a single threaded connector (bolt or screw) and at least one rosette gear on each articulating arm. The gears may be turned to tighten and loosen the articulating rods so that the receptacle and clamp may be positioned at the desired angles.

The opposing (or distal) ends of each articulating rod may comprise a ball and socket joint. One articulating rod may be connected to a receptacle (such as a cylinder receptacle) via at least one ball and socket joint. The other articulating rod may be connected to the clamp via at least one ball and socket joint. As such, both the receptacle and the clamp may rotate around these axes. Each ball and socket joint may comprise a tightening mechanism, so that the joint may be secured at a certain position in order to prevent the receptacle and/or clamp from moving or rotating.

The receptacle may be comprised of a rigid material, such as stainless steel, aluminum, carbon fiber, PVC pipe, or plastic. The receptacle may be in the shape of a cylinder or tube to receive the distal ends of various cylindrical objects, such as a fishing pole, umbrella, or flashlight.

The receptacle may also be configured to accommodate additional attachments. For example, in some example aspects, the universal holder may comprise a magnetic portion, so that an attachment (such as a magnetic bait and tackle box) may be magnetically attached to the universal holder. Other attachments to the universal holder may include a lantern or drink holder. For instance, a lantern with a rotating handle may be affixed to the universal holder via a hook attachment that is connected to the universal holder. The hook attachment may be connected to the body of the cylindrical receptacle or the clamp in some examples. A drink holder attachment may also be connected to the universal holder. For example, a drink holder may comprise at least one attachment point, where the drink holder can be attached to the clamp or the receptacle via a bolt, screw, quick-detach mounts, snaps, buckles, nuts, rivets, buttons, and flush cup mounts, among other fasteners. Each of these fasteners may be utilized by the universal holder to allow other various attachments to connect to the universal holder.

Other attachments may include a cell phone holder or a camera holder. Each of these attachments may be connected to the universal holder via a fastener mechanism as described above. For example, a cell phone holder may be attached to a portion of one of the articulating rods via a ball and socket joint and a threaded connector and handle to tighten and loosen the cell phone holder attachment.

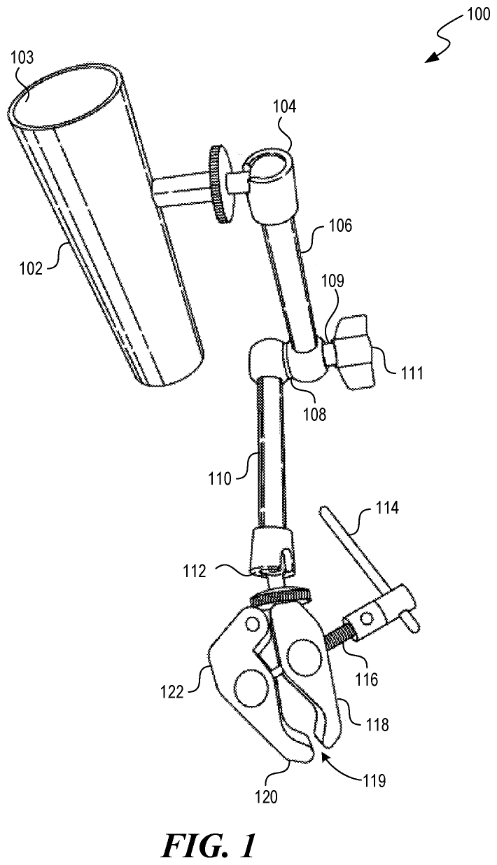

FIG. 1 is a side perspective view which illustrates a particular embodiment of the universal holder. The universal holder 100 comprises a cylindrical receptacle 102. The cylindrical receptacle may be comprised of stainless steel in some examples. The cylindrical receptacle may also be comprised of other materials, such as aluminum, carbon fiber, polyvinyl chloride, or plastic. The cylindrical receptacle 102 is connected to a first articulating rod 106 via at least one rotating ball and socket joint 104 with a threaded end. The ball and socket joint 104 connecting the cylindrical receptacle 102 to the articulating rod 106 allows the cylindrical receptacle 102 to be moved in various positions, up and down and side to side. The ball and socket joint 104 may comprise a tightening mechanism that may be twisted to tighten and loosen the ball and socket joint, so that the cylindrical receptacle 102 can be held in place.

The articulating rod 106 is connected to a second articulating rod 110 via a shared end, with a single threaded handle 108 and two rosette gears on each articulating rod. The single threaded handle 108 allows each articulating rod to move up and down to position the cylindrical receptacle 102 in the proper position. A tightening mechanism may be connected to the single threaded handled that may be tightened or loosened to position the articulating rods 106 and 110 in the proper positions.

At a distal end of the second articulating rod 110 is another ball and socket joint 112 with a tightening mechanism. Similar to the first articulating rod, this tightening mechanism allows the second articulating rod 110 to be held in position. The ball and socket joint 112 may be connected to a clamp 122. The clamp 122 may have two opposing ends 118 and 120 that can be clamped together and separated apart.

The opposing ends of the clamp 122 may be notched padded jaws actuated by a threaded rod 116 and handle 114. The threaded rod 116 may be connected to at least one barrel nut through each jaw 118 and 120. The clamp may be non-marring and can be attached to any firm structure, sch as a chair, table, tent frame, bucket, tree branch, wheelchair, tent spike, and more. The handle 114 may be turned to tighten and loosen the ends 118 and 120 of the clamp 122.

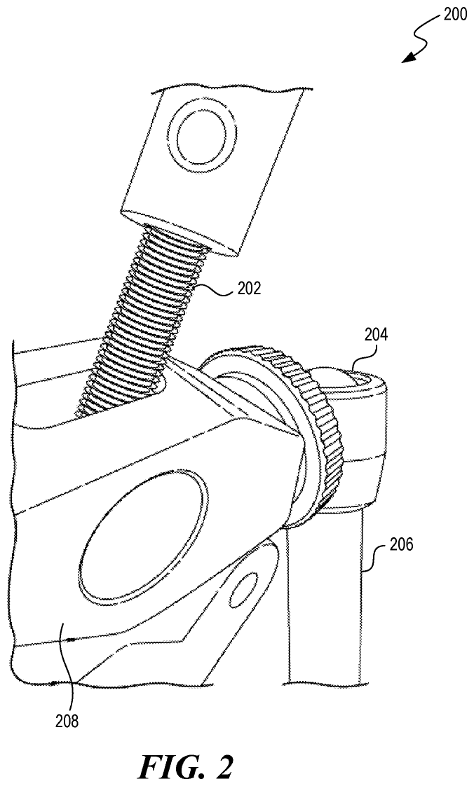

FIG. 2 is a zoomed-in perspective view which illustrates the connection point between one of the articulating rods and the clamp. The perspective of the clamp 200 in FIG. 2 shows the threaded rod 202 connected to the handle, which may control the distance between each opposing end 208 of the clamp. The clamp itself is attached to the articulating rod 206 via the ball and socket joint 204. The ball and socket joint 204 allows the clamp to move freely. The ball and socket joint also contains a tightening mechanism that may be hold the clamp in place.

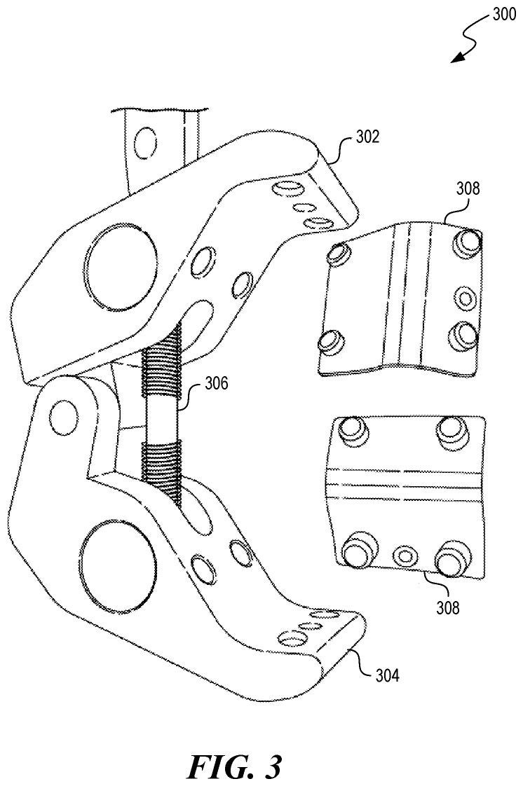

FIG. 3 is a side perspective view which illustrates a clamp connected to the universal holder. The clamp 300 has two opposed ends 302 and 304. Each opposed end may be a padded jaw, where the clamp tightness may be controlled by a single threaded rod 306 that crosses through a portion of each of the clamp ends 302 and 304. The threaded rod 306 may connect to a handle that can be used to tighten or loosen the clamp 300, i.e., control the distance of the clamp ends 302 and 304. Clamp attachments 308 may be comprised of molded synthetic rubber in some examples or stainless steel in other examples. Each receiving point on the clamp attachments 308 may comprise threaded holes to receive a screw or other fastener. The surface of the clamp attachments 308 may be comprised of non-slip and non-marring materials.

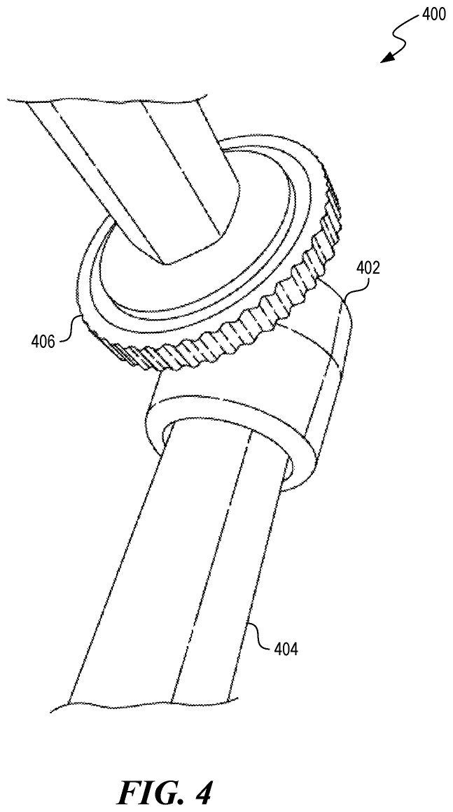

FIG. 4 is a zoomed-in perspective view which illustrates the connection point between one of the articulating rods and the universal holder 400. The articulating rod 404 connects to a holder, which may be a cylindrical receptacle or some other shaped receptacle, via the ball and socket joint 402 with a tightening gear. The ball and socket joint 402 may allow the receptacle to rotate in various directions around the distal end of the articulating rod 404. The tightening mechanism may be used to hold the receptacle in place at the junction between the articulating rod 404 and the receptacle via the ball and socket joint 402.

The universal holder apparatus may have flexibility to rotate the receptacle to a desired angle, as well as rotate the clamp at a desired angle. Variable tension locking mechanisms may be connected to the connection points of the receptacle and the clamp, whereby the locking mechanisms may be tightened and loosened via at least one threaded connector (e.g., screw) and a turning handle.

The articulating rods may be comprised of variable lengths or the same length to accommodate various size and space constraints. For example, if the universal holder was to be attached to a railing, certain railing bars may interfere with the positioning of the clamp and the receptacle. In such an example, one of the articulating rods may need to be shorter than the other articulating rod. Specifically, the articulating rod attached to the clamp may be half the length of the articulating rod that is attached to the cylindrical receptacle.

### Tightening Mechanism Systems

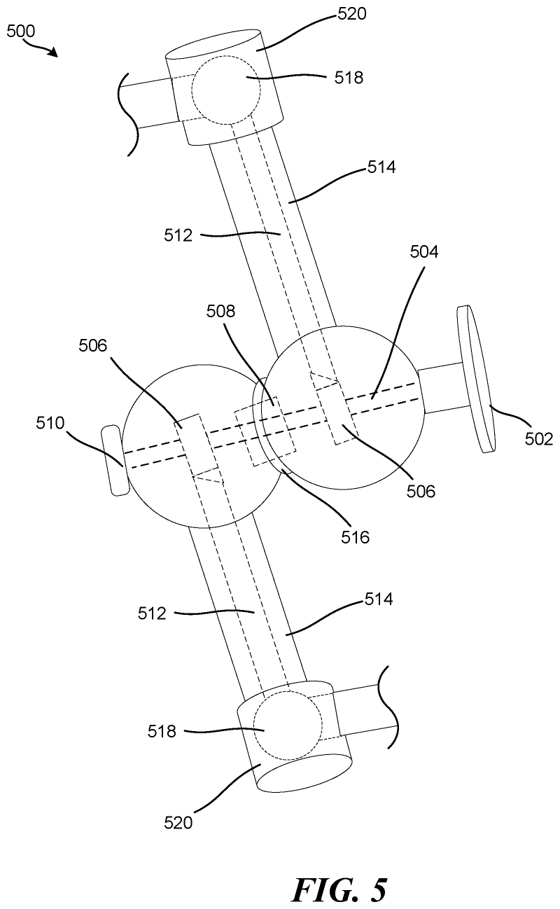

FIG. 5 illustrates a holder system 500 with an internal engagement system, in accordance with one or more embodiments. The holder system 500 may include a tightening mechanism 502, a fastening rod 504, at least one engagement mechanism 506, a spacer 508, a fastener 510, at least one engagement rod 512, at least one articulating rod 514, a rosette gear 516, at least one ball 518, and at least one socket 520. The holder system 500 may be configured to provide adjustable positioning through the internal engagement system while maintaining structural rigidity when the tightening mechanism 502 is engaged.

In some embodiments, a tightening mechanism 502 may be operatively attached to a fastening rod 504 in order to engage and tighten the holder system 500 into place. The tightening mechanism 502 may be a knob, a handle, a lever, a wheel, or another rotatable or actuatable component configured to apply force to the fastening rod 504. In some cases, the tightening mechanism 502 may be threaded to engage with corresponding threads on the fastening rod 504. The fastening rod 504 may be a screw, a bolt, a threaded rod, a pin, or another elongated fastening component. In some embodiments, the fastening rod 504 may comprise a knurled or textured surface to facilitate gripping and rotation.

The fastening rod 504 may be configured to thread through the at least one engagement mechanism 506. In some embodiments, the fastening rod 504 passes through apertures or openings within the engagement mechanism 506. Multiple engagement mechanisms 506 may be positioned along the fastening rod 504. In some embodiments, the holder system 500 may include two engagement mechanisms 506 positioned on opposite sides of a spacer 508. In some embodiments, no spacer 508 is present. The fastening rod 504 may extend through each engagement mechanism 506 to provide a unified tightening action across the holder system 500.

The holder system 500 may further comprise a spacer 508 configured to keep the engagement mechanisms 506 properly spaced apart. The spacer 508 may be positioned centrally within the assembly between the engagement mechanisms 506. In some cases, the spacer 508 may maintain a predetermined distance between the engagement mechanisms 506 to ensure proper alignment and engagement. The spacer 508 may be cylindrical, tubular, or another shape configured to fit within the internal structure of the holder system 500. The tightening mechanism 502 may be connected to a fastener 510 in order to tighten the system. The fastener 510 may be a nut, a washer, a retaining clip, or other component configured to secure the fastening rod 504 in position.

The engagement mechanism 506 may be configured to operatively engage with an engagement rod 512 when the tightening mechanism 502 is tightened. In some embodiments, the engagement mechanism 506 and the engagement rod 512 each have a tapered end configured to engage with each other. The tapered end of the engagement mechanism 506 may have an angled or conical surface that corresponds to a complementary tapered surface on the engagement rod 512. When the tightening mechanism 502 is tightened, force may be applied along the tapered end of the engagement mechanism 506 into the tapered end of the engagement rod 512, pushing the engagement rod 512 in a direction substantially perpendicular to the fastening rod 504. In some embodiments, the engagement rod 512 has a tapered end while the engagement mechanism 506 does not. In other embodiments, the engagement mechanism 506 has a tapered end while the engagement rod 512. The engagement rod 512 may be tapered on both ends.

In some embodiments, the engagement rod 512 is configured to be moved to engage with a ball 518 and socket 520 joint positioned on the opposite end of the engagement rod 512 from the engagement mechanism 506. As the engagement rod 512 is pushed in a direction substantially perpendicular to the fastening rod 504 by the engagement mechanism 506, the engagement rod 512 may contact and apply pressure to the ball 518 within the socket 520. In some cases, the engagement rod 512 may press against the ball 518 to restrict movement of the ball 518 within the socket 520. When the engagement mechanism 506, engagement rod 512, and ball 518 and socket 520 are fully engaged, the ball 518 joint may be held firmly in place, thereby locking the position of components connected through the ball 518 and socket 520 joint, and holding any attachments connected to the ball 518 in place.

In some embodiments, different joints may be used instead of a ball 518 and socket 520 joint. For example, the holder system 500 may utilize a pivot joint, a hinge joint, a universal joint, a gimbal joint, or a swivel joint. In some cases, the holder system 500 may include a combination of different joint types at various connection points. The engagement rod 512 may be configured to engage with any of these alternative joint types to restrict movement when the tightening mechanism 502 is tightened.

In some embodiments, the holder system 500 comprises at least one articulating rod 514 housing the fastening rod 504, engagement mechanism 506, spacer 508, and/or engagement rod 512. In some embodiments, the articulating rod 514 may be hollow or tubular to accommodate the internal engagement system. In some embodiments, multiple articulating rods 514 extend between two ball 518 and socket 520 assemblies positioned at opposite ends of the holder system 500. Each socket 520 may receive a corresponding ball 518, forming ball joint connections that enable rotational movement and positioning flexibility at each end of the articulating rod 514.

In some embodiments, at least one rosette gear 516 may connect the at least one articulating rod 514 to other components of the holder system 500. The rosette gear 516 may be positioned along the articulating rod 514 and may enable rotational adjustment between connected articulating rods 514. The rosette gear 516 may comprise teeth or ridges configured to interlock with a corresponding rosette gear on an adjacent articulating rod 514 or component. The spacer 508 may be used to maintain internal and external spacing within the holder system 500. In some cases, the spacer 508 may ensure proper alignment between at least one rosette gear 516 and/engagement mechanisms 506.

In some embodiments, the internal engagement system of the holder system 500 provides a single-action tightening capability. When the tightening mechanism 502 is actuated, the fastening rod 504 may engage the engagement mechanisms 506 together, causing the rosette gears 516 to engage the articulating rods 516 in place and the engagement rods 512 to engage with the ball 518 and socket 520 joints at both ends of the articulating rod 514 substantially simultaneously. In some embodiments, the holder system 500 may lock multiple joints with a single tightening action. The internal engagement system may allow a user to position the holder system 500 at a desired orientation and then secure entire holder system 500 in position by tightening the tightening mechanism 502.

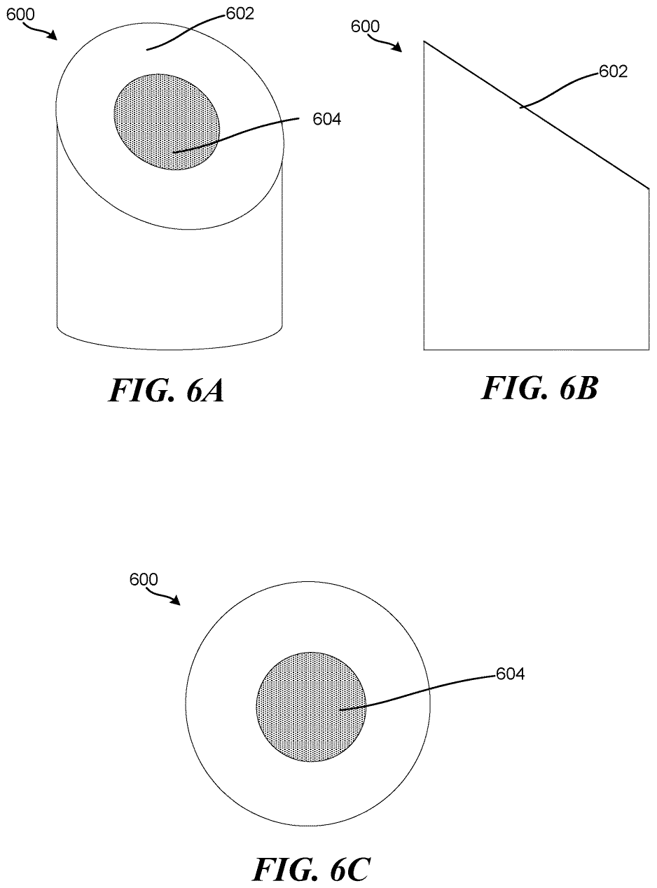

FIGS. 6A-6C illustrate an engagement mechanism 600 with an aperture 604, in accordance with one or more embodiments. In some embodiments, the engagement mechanism 600 has a generally cylindrical body with a rounded upper portion. The engagement mechanism 600 may be configured to engage with an engagement rod, such as the engagement rod 512, when a tightening mechanism, such as tightening mechanism 502, is tightened, as described above with respect to FIG. 5.

The engagement mechanism 600 may include a tapered end 602 at a first end of the engagement mechanism 600. The tapered end 602 may be configured to narrow toward an upper edge of the engagement mechanism 600. In some embodiments, an entire side of the engagement mechanism 600 is tapered. In some embodiments, only a portion of a first end of the engagement mechanism 600 is tapered. In a preferred embodiment, half of the first end of the engagement mechanism 600 is tapered. The tapered end 602 may facilitate engagement with or alignment of other components of a holder system, such as an engagement rod. The tapered end 602 may correspond to a complementary tapered surface on an engagement rod, such as the engagement rod 512, to transfer force when a fastening rod is tightened.

An aperture 604 may be positioned centrally within the engagement mechanism 600. The aperture 604 may be configured to receive and/or engage with corresponding elements such as a fastening rod. In some embodiments, the aperture 604 is threaded to engage with a threaded fastening rod, such as the fastening rod 504. When a threaded fastening rod engages with the threaded aperture 604, rotation of a tightening mechanism may draw the engagement mechanism 600 along the fastening rod to apply force against an engagement rod.

In some embodiments, the engagement mechanism 600 may be configured to engage with a fastening rod through other configurations. For example, the aperture 604 may include a friction fit surface configured to grip a fastening rod when compressed. In some cases, the aperture 604 may include a keyed profile configured to receive a correspondingly shaped fastening rod. In some embodiments, the engagement mechanism 600 may include a set screw or locking pin configured to secure the engagement mechanism 600 to a fastening rod. The engagement mechanism 600 may also include a spring-loaded element configured to bias the engagement mechanism 600 against an engagement rod when a fastening rod is engaged.

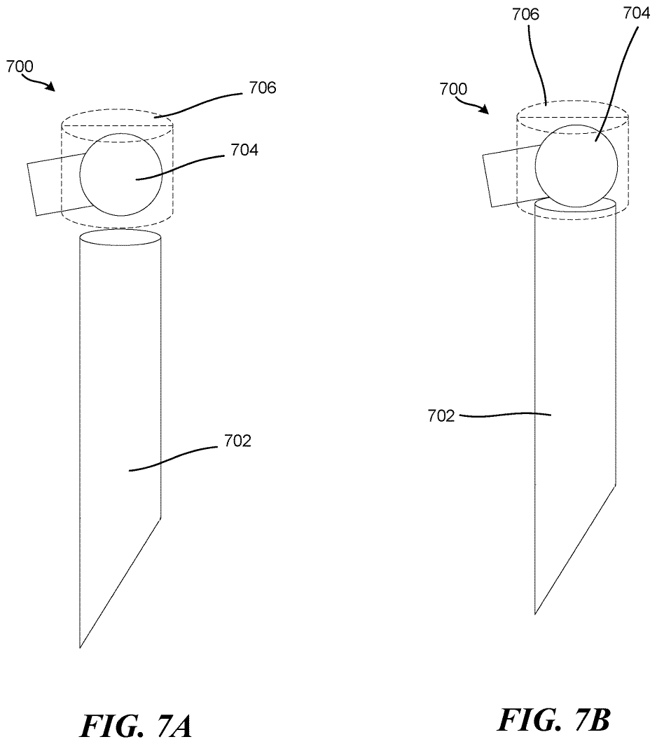

FIGS. 7A-7B illustrate an engagement system 700 with a tapered engagement rod 702, in accordance with one or more embodiments. The engagement system 700 may include an engagement rod 702, a ball 704, and a socket 706. FIG. 7A illustrates an engagement system 700 in an unengaged state, while FIG. 7B illustrates an engagement system 700 in an engaged state.

The socket 706 may be configured to receive and retain the ball 704 to form a ball and socket joint. The ball 704 may be positioned within the socket 706, allowing for rotational movement of the ball 704 within the socket 706. In some embodiments, the ball 704 includes a protruding portion that extends outward from the socket 706 and is configured to attach to an attachment. The arrangement of the ball 704 and socket 706 may provide an articulating connection point that enables adjustable positioning through the ball and socket arrangement.

In some embodiments, the socket 706 may include a groove along one side of the socket 706. In some embodiments, the groove is a removed portion of the socket 706 that allows the protruded portion of the ball to move without being blocked by the socket. The groove may allow the ball 704 and any attachments thereto to have a greater range of rotation compared to a socket without a groove. In some cases, the socket 706 may be freely rotated such that the groove may be repositioned. In some embodiments, the socket is configured to allow the ball to perform a full rotation with an attachment.

In some embodiments, the engagement rod 702 may feature a tapered configuration that narrows toward a distal end of the engagement rod 702. The tapered engagement rod 702 may facilitate secure engagement with other components of a holder system, such as an engagement mechanism 600 described above with respect to FIG. 6. The tapered configuration of the engagement rod 702 may correspond to a complementary tapered surface on an engagement mechanism, such as the engagement mechanism 506 or the engagement mechanism 600, to transfer force when a fastening rod is tightened. In some embodiments, each side of the engagement rod 702 is tapered. In the illustrated embodiment, a side of the engagement rod 702 that engages the ball 704 is flat. A flat engagement surface may provide a broader contact area against the ball 704 when the engagement rod 702 is engaged. In some embodiments, the engagement rod 702 may include a second socket on one end of the engagement rod 702. The second socket may be configured to engage the ball 704 in place while allowing the ball 704 to freely rotate when unengaged. The second socket may receive a portion of the ball 704 and may restrict movement of the ball 704 when the engagement rod 702 is engaged with the ball 704.

In some cases, the engagement system 700 may utilize alternative configurations. For example, the engagement rod 702 may include a concave surface configured to conform to a curvature of the ball 704. In some embodiments, the engagement rod 702 may include a friction pad or textured surface configured to grip the ball 704 when engaged. In some cases, the engagement rod 702 may be spring-loaded to bias the engagement rod 702 toward the ball 704. In some embodiments, the socket 706 may include multiple grooves positioned at different locations around the socket 706 to provide multiple directions of extended rotation for the ball 704, or to allow for different levels of engagement between the engagement rod 702 and the ball 704.

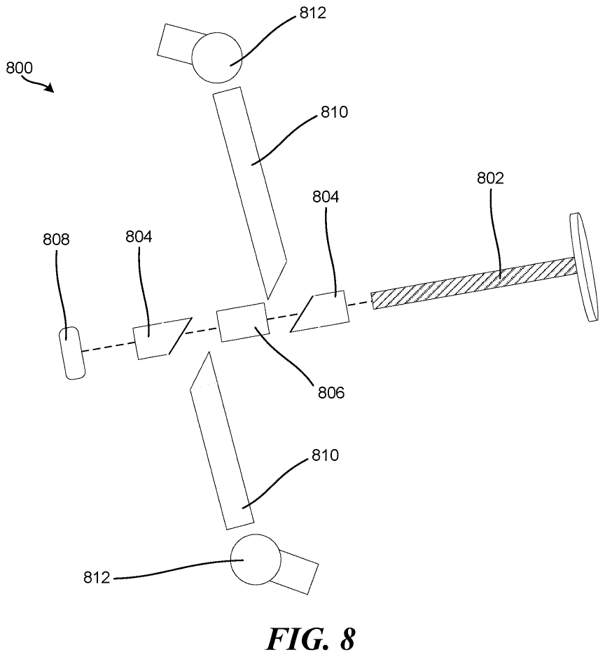

FIG. 8 illustrates an exploded view of an engagement system 800, in accordance with one or more embodiments. In some embodiments, the engagement system 800 comprises a fastening rod 802, two engagement mechanisms 804, a spacer 806, a fastener 808, two engagement rods 810, and two ball joints 812. The exploded view illustrates the spatial relationship between the components and how the components may be assembled to form the internal engagement system.

In some embodiments, the fastening rod 802 include flanged ends configured to secure the assembly and prevent the fastening rod 802 from passing entirely through the engagement mechanisms 804. These flanged ends may further comprise a tightening mechanism, such as a wheel, a knob, or a twistable component configured to tighten the system. In some embodiments, the fastening rod 802 includes a textured or knurled surface along a portion of the fastening rod 802 to facilitate gripping during assembly or adjustment.

The two engagement mechanisms 804 may be positioned on opposite sides of a spacer 806. Each engagement mechanism 804 may have a generally cylindrical form with angled surfaces configured to engage with corresponding engagement rods 810. As described above with respect to the engagement mechanism 506 and the engagement mechanism 600, the engagement mechanisms 804 may include tapered surfaces configured to transfer force to the engagement rods 810 when the fastening rod 802 is tightened.

The spacer 806 may be located at a central junction point of the engagement system 800 between the two engagement mechanisms 804. The spacer 806 may maintain a predetermined distance between the engagement mechanisms 804 to ensure proper alignment during engagement. In some embodiments, the spacer 806 may be omitted depending on the configuration of the engagement system 800.

The fastener 808 may be positioned at one end of the engagement system 800 and may be configured to secure the components together. In some embodiments, the fastener 808 may be a nut configured to engage with threads on the fastening rod 802. When the fastener 808 is tightened against the fastening rod 802, the engagement mechanisms 804 may be drawn together, compressing the spacer 806 and causing the tapered surfaces of the engagement mechanisms 804 to apply force against the engagement rods 810.

The two engagement rods 810 may extend outward from the central assembly in opposite directions. Each engagement rod 810 may terminate at a ball joint 812. As described above with respect to the engagement rod 512 and the engagement rod 702, the engagement rods 810 may include tapered ends configured to receive force from the engagement mechanisms 804. When the fastener 808 is tightened, the engagement mechanisms 804 may push the engagement rods 810 outward in directions substantially perpendicular to the fastening rod 802, causing the engagement rods 810 to engage with the ball joints 812.

The ball joints 812 may enable rotational movement and articulation of connected components when the engagement system 800 is in an unengaged state. In some embodiments, when the engagement rods 810 are pushed outward by the engagement mechanisms 804, the engagement rods 810 contact and apply pressure to the ball joints 812, restricting movement of the ball joints 812 and locking the position of any attachments connected to the ball joints 812. In some embodiments, the ball joints 812 may be received within corresponding sockets, such as the socket 520 or the socket 706 described above.

The arrangement of the fastening rod 802, engagement mechanisms 804, spacer 806, fastener 808, engagement rods 810, and ball joints 812 may allow for single-action tightening of the engagement system 800. In some cases, tightening the fastener 808 may simultaneously engage both ball joints 812 at opposite ends of the engagement system 800, locking multiple articulation points with a single tightening action.

### Attachment Systems

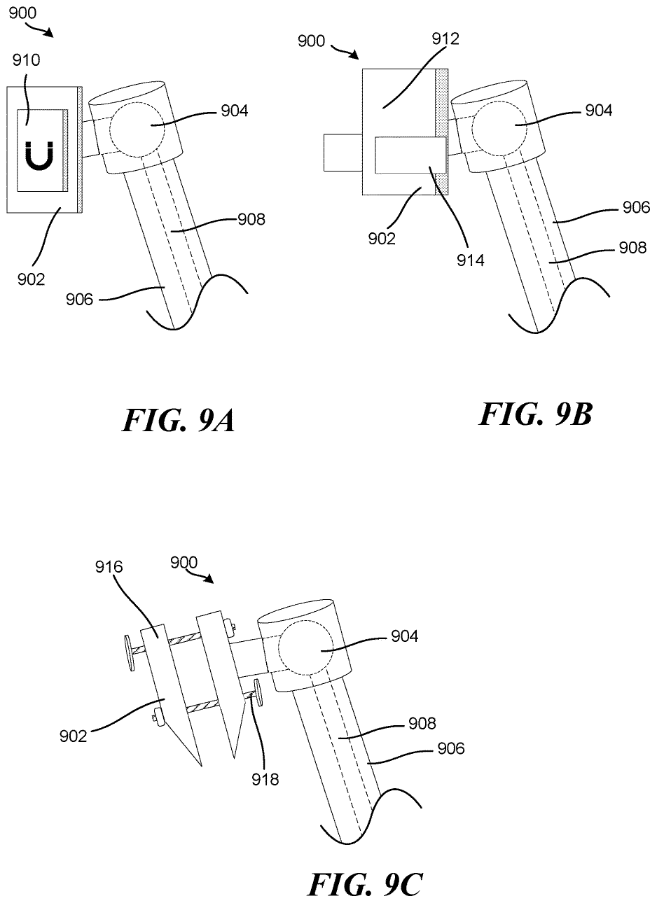

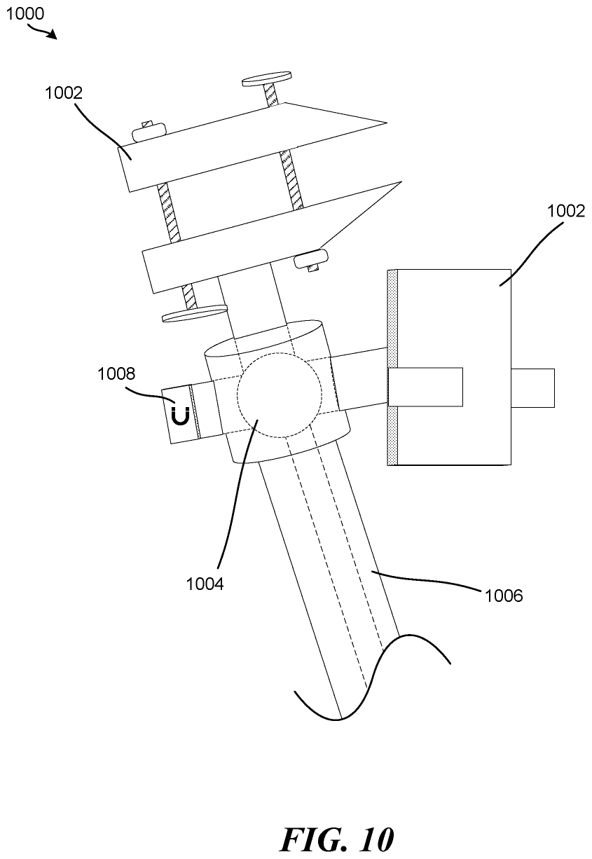

FIGS. 9A-9C illustrate a holder system 900 with various attachment configurations, in accordance with one or more embodiments. The holder system 900 may include an articulating rod 906, a ball joint 904, an engagement rod 908, and an attachment 902. As described above with respect to the articulating rod 514 and the ball joint formed by the ball 518 and socket 520, the articulating rod 906 may connect to the ball joint 904 to provide rotational adjustment and positioning flexibility.

In some embodiments, an attachment 902 connects to a ball joint 904. For example, the attachment 902 may be threaded onto a protruding portion of the ball joint 904. In some cases, the attachment 902 may snap onto the ball joint 904 through a friction fit or interference fit. In some embodiments, the attachment 902 is removably attachable to the ball joint. In some embodiments, the attachment 902 is configured to permanently attach to the ball joint 904. The attachment 902 may connect to the ball joint 904 through a quick-release mechanism, a bayonet mount, a magnetic connection, and/or a pin and detent arrangement.

The attachment 902 may be configured to hold a variety of objects. In some embodiments, the attachment 902 may be a surface with a magnetic portion 910. As illustrated in FIG. 9A, the magnetic portion 910 may be configured to magnetically connect to ferromagnetic surfaces or objects. The magnetic portion 910 may allow the holder system 900 to attach to metal structures such as vehicle bodies, metal shelving, refrigerators, toolboxes, tools, fasteners, or metal beams. In some cases, the magnetic portion 910 may include one or more permanent magnets, electromagnets, or magnetic sheets. The magnetic portion 910 may also be configured to receive magnetically attachable accessories such as magnetic bait boxes, magnetic tool holders, or magnetic storage containers.

In some embodiments, the attachment 902 may be a phone holder 912 configured to hold a tablet, smartphone, mobile device and/or other known consumer electronic devices. As illustrated in FIG. 9B, the phone holder 912 may include engagement pads 914 positioned to face inward. The engagement pads 914 may be configured to grip and secure a mobile device between the engagement pads 914. The engagement pads 914 may provide comprise cushioned contact points to hold a device in place without causing damage to the device. In some cases, the engagement pads 914 are comprised of rubber, silicone, foam, and/or another soft material. The phone holder 912 and the engagement pads 914 may be adjustable to accommodate mobile devices of various sizes, including smartphones, tablets, e-readers, or portable gaming devices. In some embodiments, the phone holder 912 is configured to support a computer monitor.

In some embodiments, the attachment 902 may be a clamp 916. As illustrated in FIG. 9C, the clamp 916 may include a tightening rod 918 that controls a clamping force and a distance between gripping surfaces of the clamp 916. The tightening rod 918 may allow a user to adjust the clamp 916 to securely attach the holder system 900 to support structures of different thicknesses. The clamp 916 may be similar to the clamp 122 or the clamp 300 described above with respect to FIGS. 1-3. In some embodiments, the clamp 916 is the same as the clamp 122 described in FIG. 1. In some embodiments, the clamp 916 is configured to be tightened independently from a tightening mechanism using a tightening rod 918. In some embodiments, the clamp 916 is configured to be adjusted when a tightening mechanism (such as tightening mechanism 502 described in FIG. 5).

In some embodiments, the attachment 902 may be configured as other types of holding or mounting devices. For example, the attachment 902 may be a cylindrical receptacle configured to receive fishing rods, umbrellas, flashlights, and/or other elongated objects. In some cases, the attachment 902 may be a hook configured to hang lanterns, bags, or other items with handles. The attachment 902 may be a cup holder configured to receive beverage containers of various sizes. In some embodiments, the attachment 902 may be a camera mount configured to secure cameras, action cameras, or recording devices. The attachment 902 may be a tablet stand, a book holder, a microphone mount, or a light fixture mount.

In some embodiments, the attachment 902 may be removably attachable to the holder system 900. The removable attachment 902 may allow a user to interchange different attachments depending on the intended use of the holder system 900. In some cases, multiple attachments 902 may be provided with the holder system 900 to allow for different configurations. The ball joint 904 may enable the attachment 902 to be positioned at various angles relative to the articulating rod 906, providing flexibility in orienting objects held by the holder system 900.

### Articulating Rod Systems

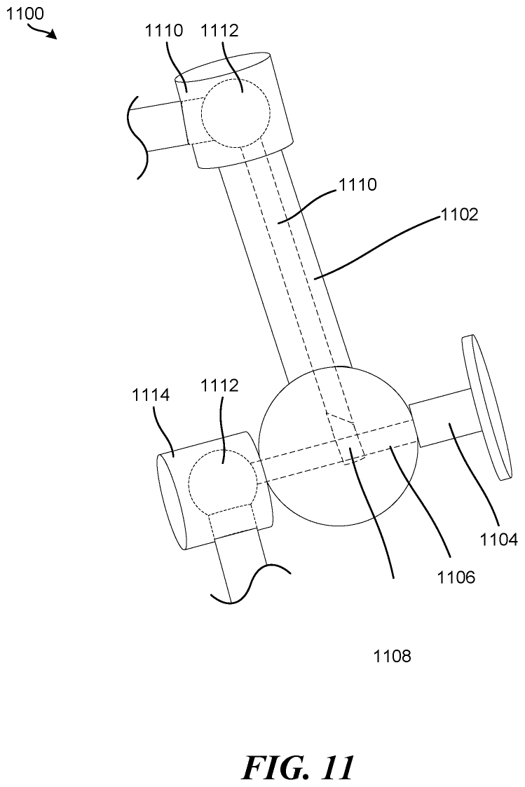

FIG. 11 illustrates a holder system 1100 with a single articulating rod 1102, in accordance with one or more embodiments. The holder system 1100 may include an articulating rod 1102, a tightening mechanism 1104, a fastening rod 1106, an engagement mechanism 1108, at least one engagement rod 1110, at least one ball 1112, and at least one socket 1114. The holder system 1100 provides a streamlined configuration compared to holder systems with multiple articulating rods while maintaining adjustability through ball 1112 and socket 1114 joints at each end of the articulating rod 1102.

In some embodiments, the articulating rod 1102 extends between two ball 1112 and socket 1114 assemblies positioned at opposite ends of the holder system 1100. Each socket 1114 may receive a corresponding ball 1112, forming ball joint connections that enable rotational movement and angular adjustment at each connection point. The ball 1112 and socket 1114 arrangement at each end of the articulating rod 1102 may allow attachments connected to the ball 1112 to be positioned at various angles relative to the articulating rod 1102.

In some embodiments, an engagement rod 1110 connects to each ball 1112 and socket 1114 assembly. As described above with respect to the engagement rod 512 and the engagement rod 702, each engagement rod 1110 may include a tapered end configured to receive force from the engagement mechanism 1108. When the tightening mechanism 1104 is tightened, the engagement mechanism 1108 may push the engagement rods 1110 outward to contact and apply pressure to the balls 1112 within the sockets 1114, restricting movement of the balls 1112 and locking the position of any attachments connected to the balls 1112.

In some embodiments, the fastening rod 1106 extends through the articulating rod 1102 and connects to the tightening mechanism 1104. The tightening mechanism 1104 may be a knob, a handle, a lever, a wheel, or another rotatable or actuatable component configured to apply force to the fastening rod 1106. The fastening rod 1106 may pass through the engagement mechanism 1108 positioned within the articulating rod 1102. When the tightening mechanism 1104 is actuated, the fastening rod 1106 may engage the engagement mechanism 1108, causing the engagement rods 1110 to engage with the ball 1112 and socket 1114 joints at both ends of the articulating rod 1102.

In some embodiments, the holder system 1100 provides single-action tightening capability. When the tightening mechanism 1104 is tightened, both ball 1112 and socket 1114 joints at opposite ends of the articulating rod 1102 may be engaged substantially simultaneously. The single-action tightening may allow a user to position the holder system 1100 at a desired orientation and then secure the holder system 1100 in position by tightening the tightening mechanism 1104.

The engagement mechanism 1108 may be similar to the engagement mechanism 506 or the engagement mechanism 600 described above. In some cases, the engagement mechanism 1108 may include a tapered surface configured to transfer force to the engagement rods 1110 when the fastening rod 1106 is tightened.

In some embodiments, the single articulating rod 1102 configuration reduces the overall size and weight of the holder system 1100 compared to configurations with multiple articulating rods. The holder system 1100 may be suitable for applications where a compact form factor is desired while still providing adjustable positioning through the ball 1112 and socket 1114 joints at each end of the articulating rod 1102.

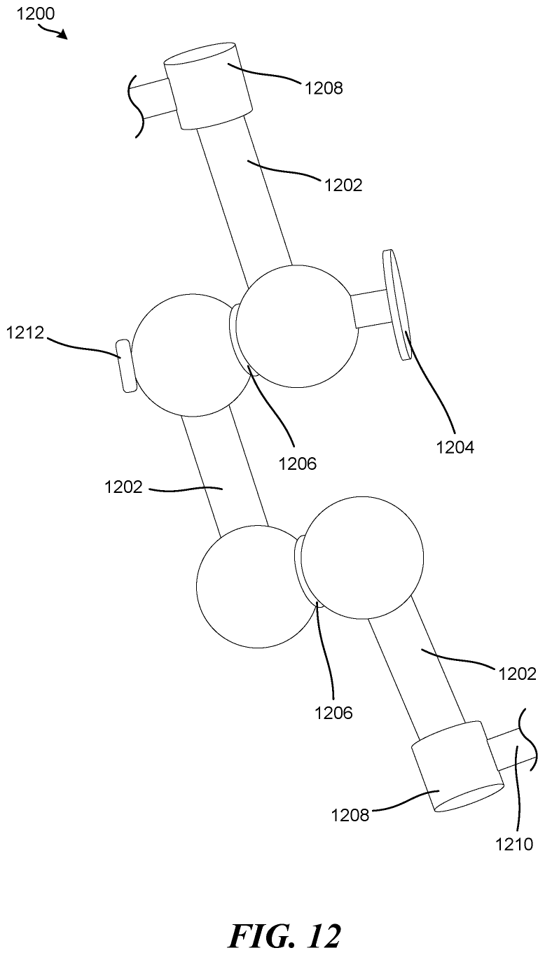

FIG. 12 illustrates a holder system 1200 with a plurality of articulating rods 1202, in accordance with one or more embodiments. The holder system 1200 may include three articulating rods 1202 connected in series to form an extended support structure. The series connection of multiple articulating rods 1202 may provide the holder system 1200 with extended reach and versatility compared to a single articulating rod 1102 configuration described above with respect to FIG. 11.

In some embodiments, each articulating rod 1202 connects to adjacent articulating rods 1202 through a rosette gear 1206. The rosette gears 1206 may enable the articulating rods 1202 to rotate about each other, similar to the rosette gear 516 described above with respect to FIG. 5. Each rosette gear 1206 may comprise teeth or ridges configured to interlock with a corresponding rosette gear 1206 on an adjacent articulating rod 1202. The rosette gears 1206 may provide multiple points of rotational adjustment along the length of the holder system 1200. In some embodiments, corresponding pairs of rosette gears 1206 are configured to engage with each other when a tightening mechanism 1204 is engaged.

In some embodiments, a ball joint 1208 is positioned at each end of the holder system 1200. The ball joints 1208 may enable rotational movement and angular adjustment of connected components, similar to the ball 518 and socket 520 joints described above with respect to FIG. 5. The ball joints 1208 at opposite ends of the holder system 1200 may allow attachments to be positioned at various angles relative to the articulating rods 1202. In some embodiments, ball joints 1208 are positioned at each articulating rod 1202.

In some embodiments, a tightening mechanism 1204 is positioned along one of the articulating rods 1202. The tightening mechanism 1204 may be configured to secure the position of the articulating rods 1202 once a desired orientation is achieved. The tightening mechanism 1204 may function similarly to the tightening mechanism 502 described above with respect to FIG. 5, engaging internal components to lock the ball joints 1208 and rosette gears 1206 in place. In some embodiments, the tightening mechanism 1204 is configured to secure the position of all of the articulating rods 1202 when engaged. In some embodiments, a fastener 1212 is configured to engage with an internal holder system (such as the internal holder system 500 described in FIG. 5) to engage the articulating rods 1202.

In some embodiments, the holder system further comprises an engagement site 1210. The engagement site 1210 may serve as a connection point for various attachments or accessories. In some embodiments, the engagement site 1210 is configured to receive attachments such as the magnetic portion 910, the phone holder 912, or the clamp 916 described above with respect to FIGS. 9A-9C.

In some embodiments, the holder system 1200 comprises more than three articulating rods 1202. Additional articulating rods 1202 may be connected in series through additional rosette gears 1206 to further extend the reach of the holder system 1200. In some cases, the holder system 1200 may comprise four, five, six, or more articulating rods 1202 depending on the desired reach and positioning flexibility.

In some embodiments, the holder system 1200 may accommodate additional attachments along the length of the holder system 1200. For example, the holder system 1200 may include one additional attachment for each articulating rod 1202 in the series. In some cases, attachments may connect to the holder system 1200 at connection points positioned between adjacent rosette gears 1206. The additional attachments may include any of the attachment types described above with respect to FIGS. 9A-9C, such as magnetic portions, phone holders, clamps, cylindrical receptacles, hooks, cup holders, or camera mounts.

### Methods and Exemplary Embodiments

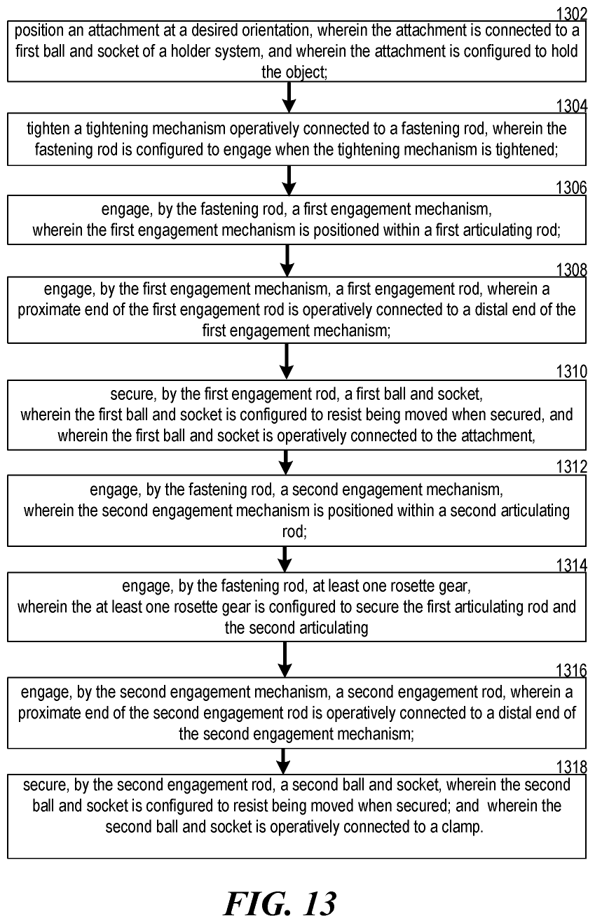

FIG. 13 is a flow diagram illustrating an example method 1300 for engaging a holder in place, in accordance with one or more embodiments. In some embodiments, the method 1300 is performed using components of the holder system 500 as described in relation to FIG. 5 above, and/or one or more components of the holder system 1100 or holder system 1200 as described in relation to FIGS. 11 and 12 above. Likewise, embodiments can include different and/or additional operations or can perform the operations in different orders.

At operation 1302, an attachment is positioned at a desired orientation. In some embodiments, the attachment is connected to a first ball and socket of a holder system, and the attachment is configured to hold an object. In some embodiments, the attachment is the same as or generally similar to the attachment 902 as described in relation to FIGS. 9A-9C above. The attachment may be a magnetic portion, a phone holder, a clamp, a cylindrical receptacle, or another holding device configured to secure various objects. In some embodiments, positioning the attachment at a desired orientation involves rotating the attachment about the first ball and socket to achieve a preferred angle relative to the articulating rod.

At operation 1304, a tightening mechanism operatively connected to a fastening rod is tightened. In some embodiments, the fastening rod is configured to engage when the tightening mechanism is tightened. In some embodiments, the tightening mechanism is the same as or generally similar to the tightening mechanism 502 as described in relation to FIG. 5 above. The tightening mechanism may be a knob, a handle, a lever, a wheel, or another rotatable or actuatable component configured to apply force to the fastening rod. In some embodiments, the tightening mechanism is a switch configured to engage the fastening rod when toggled.

At operation 1306, a first engagement mechanism is engaged by the fastening rod. The first engagement mechanism is positioned within a first articulating rod. In some embodiments, the first engagement mechanism is the same as or generally similar to the engagement mechanism 506 or the engagement mechanism 600 as described in relation to FIGS. 5 and 6A-6C above. The first engagement mechanism may include a tapered surface configured to transfer force when the fastening rod is tightened.

At operation 1308, a first engagement rod is engaged by the first engagement mechanism. In some embodiments, a proximate end of the first engagement rod is operatively connected to a distal end of the first engagement mechanism. In some embodiments, the first engagement rod is the same as or generally similar to the engagement rod 512 or the engagement rod 702 as described in relation to FIGS. 5 and 7A-7B above. The tapered surfaces of the first engagement mechanism and the first engagement rod may correspond to transfer force in a direction substantially perpendicular to the fastening rod.

At operation 1310, the first ball and socket is secured by the first engagement rod. In some embodiments, the first ball and socket is configured to resist being moved when secured. In some embodiments, the first ball and socket is operatively connected to the attachment. In some embodiments, the first engagement rod contacts and applies pressure to the ball within the socket, restricting movement of the ball and locking the position of the attachment.

At operation 1312, a second engagement mechanism is engaged by the fastening rod. In some embodiments, the second engagement mechanism is positioned within a second articulating rod. In some embodiments, the second engagement mechanism operates similarly to the first engagement mechanism, receiving force from the fastening rod when the tightening mechanism is tightened.

At operation 1314, at least one rosette gear is engaged by the fastening rod. In some embodiments, the at least one rosette gear is configured to secure the first articulating rod and the second articulating rod in a fixed position relative to each other when engaged. In some embodiments, the rosette gear is the same as or generally similar to the rosette gear 516 as described in relation to FIG. 5 above. The rosette gear may comprise teeth or ridges configured to interlock with a corresponding rosette gear on an adjacent articulating rod.

At operation 1316, a second engagement rod is engaged by the second engagement mechanism. In some embodiments, a proximate end of the second engagement rod is operatively connected to a distal end of the second engagement mechanism. In some embodiments, the second engagement rod operates similarly to the first engagement rod, being pushed outward by the second engagement mechanism when the fastening rod is tightened.

At operation 1318, a second ball and socket is secured by the second engagement rod. In some embodiments, the second ball and socket is configured to resist being moved when secured, and the second ball and socket is operatively connected to a clamp. In some embodiments, the clamp is the same as or generally similar to the clamp 916 as described in relation to FIG. 9C above. The clamp may be attached to a support structure such as a chair frame, table edge, or tent frame to hold the holder system in place.

In some embodiments, the cylindrical receptacle may be configured to receive a distal end of various elongated objects. The cylindrical receptacle may have an open end sized to accept fishing poles, umbrellas, flashlights, or other cylindrical items. The inner diameter of the cylindrical receptacle may be selected based on the intended objects to be held. In some cases, the cylindrical receptacle may include an interior lining configured to grip objects of varying diameters within a range. In some embodiments, the cylindrical receptacle comprises a magnetic portion.

In some embodiments, the cylindrical receptacle may receive a distal end of a fishing pole. The cylindrical receptacle may be sized to accommodate fishing poles of different diameters, including spinning rods, casting rods, fly rods, or ice fishing rods. The depth of the cylindrical receptacle may be sufficient to support the fishing pole in an upright or angled position while a fishing line is cast into a body of water.

In some embodiments, the cylindrical receptacle may receive a distal end of an umbrella. The cylindrical receptacle may hold beach umbrellas, patio umbrellas, or personal umbrellas. The ball and socket joint connecting the cylindrical receptacle to the articulating rod may allow the umbrella to be angled relative to the sun or rain to provide shade or protection from the elements.

In some embodiments, the cylindrical receptacle may receive a distal end of a flashlight. The cylindrical receptacle may hold flashlights, lanterns, or other portable lighting devices. The adjustable positioning provided by the articulating rods and may allow the flashlight to be directed toward a desired area.

In some embodiments, the cylindrical receptacle may be configured to receive beverage containers. The cylindrical receptacle may hold cups, bottles, cans, or other drink containers. In some cases, the inner diameter of the cylindrical receptacle may be sized to accommodate standard beverage container sizes. In some embodiments, the cylindrical receptacle may include a tapered interior configured to hold beverage containers of different diameters.

In some embodiments, the receptacle may have shapes other than cylindrical. The receptacle may be conical, rectangular, or have an irregular shape configured to receive specific objects. In some cases, the receptacle may have a square or hexagonal cross-section. The receptacle may include a flared opening configured to guide objects into the receptacle. In some embodiments, the receptacle may have a narrowed bottom portion configured to secure objects with tapered ends.

In some embodiments, the receptacle may have adjustable dimensions. The receptacle may include expandable walls configured to accommodate objects of different sizes. In some cases, the receptacle may include removable inserts configured to reduce the inner diameter for smaller objects. The removable inserts may be interchangeable to accommodate different object sizes.

In some embodiments, the receptacle may include retention features configured to secure objects within the receptacle. The retention features may include friction pads, spring clips, adjustable straps, or elastic bands. In some cases, the receptacle may include a locking mechanism configured to prevent objects from being removed unintentionally. The retention features may be positioned along the interior surface of the receptacle or at the opening of the receptacle.

In some embodiments, a magnetic portion of a holder system comprises one or more neodymium magnets, ceramic magnets, alnico magnets, and/or samarium-cobalt magnets. Neodymium magnets may provide a higher magnetic strength relative to magnet size, while ceramic magnets may provide corrosion resistance in outdoor or marine environments. In some embodiments, the magnetic portion comprises a combination of different magnet types to balance magnetic strength, weight, and environmental durability.

In some embodiments, the magnetic portion can have varying sizes and shapes depending on the intended application. The magnetic portion may be circular, rectangular, or disc-shaped. In some cases, the magnetic portion has a diameter ranging from approximately 10 millimeters to approximately 50 millimeters. Larger magnetic portions provide increased holding force for heavier ferromagnetic accessories such as tackle boxes, tool containers, or storage bins, while smaller magnetic portions may be suitable for lighter accessories such as magnetic hooks or small component trays.

The magnetic portion may be positioned on an attachment, on a side surface of an articulating rod, at an engagement site, and/or adjacent to a ball joint. In some cases, multiple magnetic portions may be distributed along the holder system to provide attachment points for ferromagnetic accessories. The magnetic portion may be recessed within a housing to protect the magnet from impact damage, or the magnetic portion may be flush-mounted to maximize contact area with ferromagnetic surfaces. In some embodiments, the magnetic portion is positioned at an engagement site.

In some embodiments, the magnetic portion is configured to connect to ferromagnetic tackle boxes, bait containers, tool organizers, and/or accessory trays. The magnetic connection allow a user to attach and detach accessories without tools or fasteners. In some cases, the magnetic portion includes a protective coating such as nickel plating, epoxy coating, or rubber overmolding to prevent corrosion and reduce the risk of scratching attached accessories. The magnetic portion may include a pivoting or articulating mount that allows the magnetic surface to be angled relative to the holder system.

In some embodiments, the holder system comprises a different number of articulating rods depending on the desired reach and positioning flexibility. The holder system may include a single articulating rod as described with respect to FIG. 11, two articulating rods as described with respect to FIG. 1, three articulating rods as described with respect to FIG. 12, or four or more articulating rods connected in series through rosette gears. In some cases, the articulating rods may be detachable from each other, allowing a user to add or remove articulating rods to customize the length and reach of the holder system. The articulating rods may be constructed from stainless steel, aluminum, carbon fiber, polyvinyl chloride, plastic, or combinations thereof.

In some embodiments, an attachment may be configured as a lantern holder comprising a hook or cradle configured to receive a rotating handle of a lantern. The lantern holder may connect to the holder system via a ball joint or may attach directly to a side portion of an articulating rod or a cylindrical receptacle. In some cases, the attachment may be a camera mount configured to secure cameras, action cameras, video recorders, or other imaging devices. The camera mount may include a standard tripod thread, a quick-release plate, or a proprietary mounting interface. In some embodiments, the attachment 902 may be a tablet stand, a book holder, a microphone mount, a light fixture mount, or a tool holder.

In some embodiments, the holder system may utilize various fastener mechanisms to connect attachments and components. The fastener mechanisms may include bolts, screws, quick-detach mounts, snaps, buckles, nuts, rivets, buttons, and flush cup mounts. In some cases, the attachment connects to the ball joint through a bayonet mount, a magnetic connection, or a pin and detent arrangement. The fastener mechanisms may allow attachments to be removably attachable to the holder system, enabling a user to interchange different attachments depending on the intended use. In some embodiments, the fastener mechanisms may provide a permanent connection between the attachment and the holder system.

In some embodiments, a clamp may be constructed from alternative materials including molded synthetic rubber, stainless steel, aluminum, reinforced plastic, or composite materials. The padded ends of the clamp may comprise non-slip and non-marring materials configured to grip support structures without causing damage. In some cases, the clamp includes interchangeable jaw inserts configured to accommodate different support structure shapes and sizes. The articulating rods may include internal reinforcement structures, hollow tubular configurations, or solid rod configurations depending on the desired strength and weight characteristics. The cylindrical receptacle may include an interior lining comprising rubber, foam, or another cushioning material configured to grip objects of varying diameters.

In some embodiments, the holder system may be configured to attach to various mounting structures including folding chair frames, table edges, tent frames, buckets, tree branches, wheelchairs, tent spikes, vehicle components, boat railings, dock posts, fence posts, and workbenches. For example, a clamp may be adjustable to accommodate support structures of different thicknesses ranging from thin tubing to thick beams. In some cases, a magnetic portion may allow the holder system to attach directly to ferromagnetic surfaces such as vehicle bodies, metal shelving, refrigerators, toolboxes, or metal beams without requiring a clamp. The holder system may be used in outdoor environments including fishing, camping, beach activities, and sporting events, as well as indoor environments including workshops, offices, and home settings.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. An apparatus for holding an object, comprising:
a tightening mechanism;
a fastening rod,
wherein the fastening rod is operatively connected to the tightening mechanism;
a first articulating rod,
wherein the first articulating rod comprises a first engagement mechanism operatively connected to the fastening rod,
wherein the first articulating rod comprises a first engagement rod with a first proximate end and a first distal end,
wherein the first proximate end of the first engagement rod is operatively connected to the first engagement mechanism,
wherein the first distal end of the first engagement rod is configured to engage with a first ball and socket, and
wherein the first ball and socket comprises a first protruded portion configured to engage with an attachment; and
a second articulating rod,
wherein the second articulating rod comprises a second engagement mechanism operatively connected to the fastening rod,
wherein the second articulating rod comprises a second engagement rod with a second proximate end and a second distal end,
wherein the second proximate end of the second engagement rod is operatively connected to the second engagement mechanism,
wherein the second distal end of the second engagement rod is configured to engage with a second ball and socket, and
wherein the second ball and socket comprises a second protruded portion configured to engage with a clamp.

2. The apparatus for holding an object of claim 1, wherein the attachment is a first attachment, the apparatus further comprising:
a second attachment,
wherein the first ball and socket is configured to engage with the second attachment.

3. The apparatus for holding an object of claim 1, wherein the attachment is removably attachable from the first ball and socket.

4. The apparatus for holding an object of claim 3, wherein the attachment comprises a first magnetic portion configured to removably attach to the first ball and socket comprising a second magnetic portion.

5. The apparatus for holding an object of claim 1, wherein the attachment is a phone holder.

6. The apparatus for holding an object of claim 1, wherein the attachment is a second clamp.

7. The apparatus for holding an object of claim 1, wherein the first engagement mechanism comprises a tapered surface configured to receive the first engagement rod.

8. The apparatus for holding an object of claim 1, wherein the first proximate end of the first engagement rod comprises a tapered surface configured to receive the first distal end of the first engagement mechanism.

9. The apparatus for holding an object of claim 1, wherein the first distal end of the first engagement mechanism comprises a tapered surface configured to receive the first proximate end of the first engagement rod.

10. The apparatus for holding an object of claim 1, further comprising:
an engagement pad operatively connected to the attachment.

11. A method for securing an object in position, the method comprising:
positioning an attachment at a desired orientation,
wherein the attachment is connected to a first ball and socket of a holder system, and
wherein the attachment is configured to hold the object;
tightening a tightening mechanism operatively connected to a fastening rod,
wherein the fastening rod is configured to engage when the tightening mechanism is tightened;
engaging, by the fastening rod, a first engagement mechanism,
wherein the first engagement mechanism is positioned within a first articulating rod;
engaging, by the first engagement mechanism, a first engagement rod,
wherein a proximate end of the first engagement rod is operatively connected to a distal end of the first engagement mechanism;
securing, by the first engagement rod, a first ball and socket,
wherein the first ball and socket is configured to resist being moved when secured, and
wherein the first ball and socket is operatively connected to the attachment;
engaging, by the fastening rod, a second engagement mechanism,
wherein the second engagement mechanism is positioned within a second articulating rod;
engaging, by the fastening rod, at least one rosette gear,
wherein the at least one rosette gear is configured to secure the first articulating rod and the second articulating rod in a fixed position relative to each other when engaged;
engaging, by the second engagement mechanism, a second engagement rod,
wherein a proximate end of the second engagement rod is operatively connected to a distal end of the second engagement mechanism; and
securing, by the second engagement rod, a second ball and socket,
wherein the second ball and socket is configured to resist being moved when secured, and
wherein the second ball and socket is operatively connected to a clamp.

12. The method for securing an object in position of claim 11, wherein the first ball and socket and the second ball and socket are secured substantially simultaneously.

13. The method for securing an object in position of claim 11, the method further comprising:
loosening the tightening mechanism,
wherein loosening the tightening mechanism disengages the first engagement rod from the first ball and socket, disengages the second engagement rod from the second ball and socket, and disengages the at least one rosette gear; and
positioning the attachment at a second desired orientation.

14. The method for securing an object in position of claim 11, wherein the attachment comprises a magnetic portion.

15. An apparatus for holding an object, comprising:
an articulating rod comprising a first end and a second end;
a first ball and socket positioned at the first end of the articulating rod,
wherein the first ball and socket is configured to engage with a first attachment;
a second ball and socket positioned at the second end of the articulating rod,
wherein the second ball and socket is configured to engage with a second attachment;
a tightening mechanism operatively connected to the articulating rod;
a fastening rod operatively connected to the tightening mechanism,
wherein the fastening rod is configured to engage when the tightening mechanism is tightened, and
wherein the fastening rod extends through the articulating rod, an engagement mechanism positioned within the articulating rod,
wherein the engagement mechanism is operatively connected to the fastening rod, and
wherein the engagement mechanism is configured to engage an engagement rod when the tightening mechanism is tightened; and
the engagement rod comprising a proximate end and a distal end positioned within the articulating rod,
wherein the proximate end of the engagement rod is operatively connected to the engagement mechanism, and
wherein the distal end of the engagement rod is configured to secure the first ball and socket in place when engaged.

16. The apparatus for holding an object of claim 15, wherein the second attachment is a clamp.

17. The apparatus for holding an object of claim 15, wherein the fastening rod is configured to secure the second ball and socket in place when engaged.

18. The apparatus for holding an object of claim 15, further comprising:
a second articulating rod,
wherein the second articulating rod is connected to the articulating rod via at least one rosette gear,
wherein the at least one rosette gear is configured to engage when the tightening mechanism is tightened, and
wherein the at least one rosette gear is configured to secure the articulating rod and the second articulating rod in a fixed position relative to each other when engaged.

19. The apparatus for holding an object of claim 18, further comprising:
a third articulating rod,
wherein the third articulating rod is connected to the second articulating rod via a second at least one rosette gear,
wherein the second at least one rosette gear is configured to engage when the tightening mechanism is tightened, and
wherein the second at least one rosette gear is configured to secure the second articulating rod and the third articulating rod in a fixed position relative to each other when engaged.

20. The apparatus for holding an object of claim 15, wherein the articulating rod is composed of aluminum.
